(19) United States
(12) Patent Application Publication
(10) Pub. No.: US 2021/0206045 A1
(43) Pub. Date: Jul. 8, 2021

(54) EXTRUSION PROCESS AND SYSTEM WITH VENT STUFFER FOR PROCESSING HYGROSCOPIC STARTING MATERIAL

(71) Applicant: NESTEC S.A., Vevey (CH)

(72) Inventors: Albert Kurnia, Konstanz (DE); Roland Lermer, Singen (DE); Theodore Tchakam-Tchasso, Saint Louis (FR)

(21) Appl. No.: 16/071,321

(22) PCT Filed: Jan. 23, 2017
(86) PCT No.: PCT/EP2017/051266

§ 371 Date: Jul. 19, 2018

(30) Foreign Application Priority Data
Jan. 25, 2016 (EP) 16152504.3

(51) Int. Cl. B29C 48/76; B29C 48/29; B29C 48/285

(52) U.S. Cl. CPC B29C 48/767; B29C 48/297; B29C 48/29

(57) ABSTRACT

The invention relates generally to an extrusion process using at least one hygroscopic starting material. More specifically, the present invention relates to an extrusion process using at least one hygroscopic starting material wherein a vent stuffer is located down-stream of a feeding location and up-stream of a first kneading and melting section.

The invention relates generally to an extrusion process using at least one hygroscopic starting material. More specifically, the present invention relates to an extrusion process using at least one hygroscopic starting material wherein a vent stuffer is located down-stream of a feeding location and up-stream of a first kneading and melting section.

It is commonly known that applying vacuum to the whole feeding system of an extruder can result in the ability to handle hygroscopic starting material of an extrusion process. Nevertheless, by fitting a bigger system to a vacuumed process more complexity and higher costs need to be addressed.

There is a persisting need for an extrusion process using at least one hygroscopic starting material. Unfortunately, the feeding of an extruder barrel with hygroscopic starting material is fraught with difficulties. A caking in the feeding area is observed by using at least one hygroscopic starting material.

The caking of the starting material avoids further feeding into the process and therefore lead to interruption times of the extrusion process as cleaning of the equipment is needed. The caking risk is being accelerated and increased by the hygroscopic property and the particle size distribution of the starting material, and the extrusion process throughput. Increasing the throughput leads to quicker caking of the hygroscopic starting material.

The object of the present invention is to improve the state of the art and to provide an extrusion process using at least one hygroscopic starting material that at least goes part way to overcome one or more of the above mentioned disadvantages of existing processes or at least provides a useful alternative. Particularly, the objective is to provide an extrusion process using at least one hygroscopic starting material: i) reduce or even eliminate caking of the hygroscopic starting material within the feeding system of an extrusion process; ii) avoid process interruption times due to caking of hygroscopic starting material within the feeding system of an extrusion process; iii) avoid putting the whole extruder feeding system under vacuum; iv) allow the excess trapped moisture inter- and/or intra-particles to escape properly out of the extrusion process; v) provide a cost effective solution; vi) avoid that the solid starting material will be withdrawn by suction; vii) increase the extrusion process throughput without caking of the hygroscopic starting material.

The object of the present invention is achieved by the subject matter of the independent claims. The dependent claims further develop the idea of the present invention.

Accordingly, the present invention provides in a first aspect an extrusion process comprising the steps of:
a) feeding an extruder barrel (7) with at least one hygroscopic starting material;
b) a vent stuffer (4) at a location down-stream of the feeding location (2),(3) of step a) and up-stream of a first kneading and melting section;
c) optionally injection of liquid (6) down-stream of the vent stuffer location (4) of step b)
d) extruding the mixture.

In a second aspect, the invention pertains to use a vent stuffer (4) in an extrusion process for feeding an extruder barrel (7) with a hygroscopic starting material. More specifically, the invention pertains to use a vent stuffer (4) in an extrusion process for feeding an extruder barrel (7) with a hygroscopic starting material at a location down-stream the feeding location (2),(3) and up-stream of a first kneading and melting section.

In a third aspect, the invention pertains to an extruder system suitable for extruding compositions with at least one hygroscopic starting material, comprising an extruder (1), a dry-feed dosing system (2), a vent stuffer (4), one or more extruder barrels (7), a liquid injection system (6) and a front plate (8), wherein the vent stuffer is at a location down-stream of the feeding location and up-stream of the a first kneading and melting section of the extruder system.

In a preferred embodiment the extrusion process is a food or confectionary extrusion process. In a more preferred embodiment the extrusion process is a food extrusion process.

In a preferred embodiment the extruder system is a food or confectionary extruder system. In a more preferred embodiment the extruder system is a food extruder system.

In a preferred embodiment the extrusion process does not include a vent stuffer (4) at a location down-stream of a first kneading and melting section. In a preferred embodiment the extrusion process does not include a vent stuffer (4) at a location down-stream of a first kneading and melting section and a front plate (8).

In a preferred embodiment the extruder system does not include a vent stuffer (4) at a location down-stream of a first kneading and melting section. In a preferred embodiment the extruder system does not include a vent stuffer (4) at a location down-stream of a first kneading and melting section and a front plate (8).

It has now been found by the inventors that using a vent stuffer in an extrusion process for feeding an extruder barrel with a hygroscopic starting material at a location down-stream the feeding location and up-stream of a first kneading and melting section has certain desirable and surprising characteristics. The extrusion process of the present disclosure allows the continuous production of an extruded product using at least one hygroscopic starting material.

Through the vent stuffer down-stream of the feeding location of at least one hygroscopic starting material and up-stream of a first kneading and melting section reduction or even suppression of caking of the hygroscopic starting material within the feeding system of an extrusion process is achieved. To be not bound by theory it is expected that water always contained as moisture within a dry mix will evaporate during the kneading and melting section of the extruder barrels. The evaporated water is flowing up-stream towards the feeding location and accelerates caking of at least one hygroscopic starting material. A hygroscopic starting material contained within the dry mix, which causes the caking, is influencing all other materials. In case only vacuum would be applied without using a vent stuffer with vacuum, most of the dry mix will be withdrawn by suction. By using a vent stuffer the dry mix will be not withdrawn by suction.

The term “hygroscopic” means a product which has a water activity (aw) between 0.1 to 0.4 and a glass transition temperature (Tg) below 40° C. at the corresponding aw, preferably between −10° C. to 40° C., e.g. maltodextrin, yeast extracts, dried biohydrolysates etc.

The term “vent stuffer” means a rotating, preferably co-rotating, intermeshing twin screw auger. The vent stuffer pushes materials back into the extruder process section that might “fly out” due to a high vent vapor velocity and/or low melt viscosity materials being pulled by the vacuum. It is designed to operate with vacuum. A vent stuffer without vacuum is not considered part of the invention. The vacuum of the vent stuffer is selected from 400 to 950 mbar, preferably between 500 to 950 mbar, more preferably between 600 to 950 mbar, preferably between 600 to 800 mbar. In a preferred embodiment the vent stuffer is located within the next extruder barrel down-stream the feeding location, preferably the vent stuffer is located within the next extruder barrel down-stream the feeding location and up-stream of a first kneading and melting section, more preferably the vent stuffer is located within the second extruder barrel. In an embodiment of the invention no vent stuffer is located down-stream of a first kneading and melting section.

The terms “food,” “food product” and “food composition” mean a product or composition that is intended for ingestion by an animal, including a human, and provides at least one nutrient to the animal or human. The present disclosure is not limited to a specific animal.

“Extrusion” is a process used to create objects of a fixed cross-sectional profile. A material is pushed or pulled through a die of the desired cross-section. The two main advantages of this process over other manufacturing processes are its ability to create very complex cross-sections, and to prepare products that are brittle, because the material only encounters compressive and shear stresses. Extruders typically comprise an extruder barrel within which rotates a close fitting screw. The screw is made up of screw elements, some of which are helical screw threads to move material through the extruder barrel. Material is introduced into the extruder barrel toward one end, moved along the extruder barrel by the action of the screw and is forced out of the extruder barrel through a nozzle or die at the other end. The rotating screw mixes and works the material in the barrel and compresses it to force it through the die or nozzle. The degree of mixing and work to which the material is subjected, the speed of movement of the material through the extruder barrel and thus the residence time in the extruder barrel and the pressure developed in the extruder barrel can be controlled by the pitch of the screw thread elements, the speed of rotation of the screw and the rate of introduction of material into the extruder barrel. The extruder barrel comprises multiple extruder barrel sections which are joined end to end. Multiple extruder barrel sections are required to carry out different processes involved in extrusion such as conveying, kneading, mixing, devolatilizing, metering and the like. Each extruder barrel section comprises a liner which is press fit into an extruder barrel block, and heating and cooling elements are provided to regulate temperature of extruder barrel section within permissible range. The total length of an extrusion process can be defined by its modular extrusion barrel length. An extruder barrel is described by its unit of diameter.

The extruder according to the method of the present invention may be, for example, a co-rotating, intermeshing double screw extruder; a counter rotating, non-intermeshing double screw extruder; a single screw reciprocating extruder; or a single screw non reciprocating extruder. The powder conveying section comprises screw elements which are capable of rapidly delivering a dry powder to a downstream extrusion process. Conveying section screw elements are typically screw elements having a relatively wide pitch and which are forward flighted. Typically the kneading and melt section provides for the application of externally provided heat as well as that produced by shearing. Typical screw elements used in a kneading and melting zone include forward and reverse flighted kneading blocks.

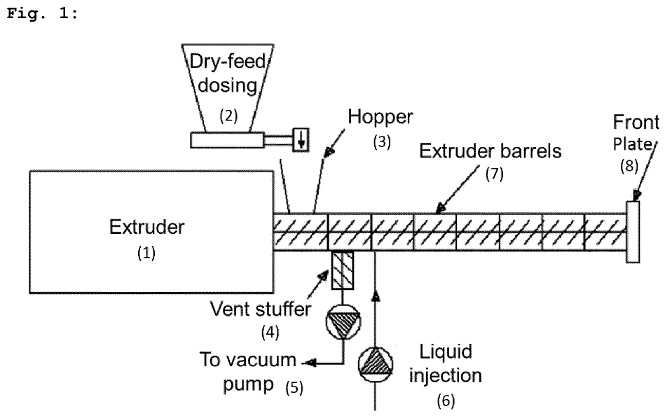

As generally illustrated in FIG. 1, the present disclosure provides an extrusion process using at least one hygroscopic starting material wherein a vent stuffer (4) at a location down-stream of the feeding location (2),(3) and up-stream of a first kneading and melting section is used. The process can comprise a) feeding an extruder barrel (7) with at least one hygroscopic starting material; b) a vent stuffer (4) at a location down-stream of the feeding location (2),(3) and up-stream of a first kneading and melting section; c) optionally injection of liquid (6) down-stream of the vent stuffer location (4); d) extruding the mixture.

In a further embodiment injection of liquids (6) is included in the process and not optionally. The mixing of the dry mix with liquids is done within the extruder barrel through the mechanical energy forced. Therefore it is not necessary to form a slurry of dry mix and liquids before feeding the extruder barrel.

The term “liquids” means any liquid suitable to use within an extrusion process. Preferably liquids means water, oil, liquid fat, glucose syrup, emulsion or combination thereof.

The extruder barrels are heated to a temperature of between 80 to 180° C., preferably 80-150° C. The pressure on the front plate (6) is between 10 to 200 bar, preferably 30 to 80 bar. The screw speed is around 200-500 rpm.

As used in this specification, the words “comprises”, “comprising”, and similar words, are not to be interpreted in an exclusive or exhaustive sense. In other words, they are intended to mean “including, but not limited to”.

Those skilled in the art will understand that they can freely combine all features of the present invention disclosed herein. In particular, features described for the composition of the present invention may be combined with the process for the preparation of the composition, and vice versa. Further, features described for different embodiments of the present invention may be combined. Further advantages and features of the present invention are apparent from the examples.

### EXAMPLES

The invention is further described with reference to the following examples. It will be appreciated that the invention as claimed is not intended to be limited in any way by these examples. The following recipe is used to demonstrate the beneficial effect of a vent stuffer using hygroscopic starting material within an extrusion process.

| Ingredients | Weight-% |
|---|---|
| Yeast Extract | 30 |
| Powdered Biohydrolysates | 30 |
| Maltodextrine | 15 |
| Sugar | 10 |
| Salt | 15 |

A dry mix of the above mentioned ingredients are added by a dry-feed dosing to an extruder barrel.

In case no vent stuffer was used within the second extruder barrel the process had to be stopped after 1 hour at a throughput of 150 kg/h as caking of the hygroscopic starting material occurred in the feeding area of the extruder system.

In case a vent stuffer was used at a location down-stream of the feeding location and up-stream of a first kneading and melting section (within the second extruder barrel) no caking of the hygroscopic starting material occurred within the process after 3 hour at a throughput of 300 kg/h and a vacuum of the vent stuffer of 700 mbar. It has been observed that a higher throughput will result in a quicker caking in case no vent stuffer is used. Therefore with the usage of a vent stuffer at a location down-stream of the feeding location and up-stream of a first kneading and melting section the throughput of extruded product has been increased as well as the operation time without any caking has been observed.

1. An extrusion process comprising the steps of:
a) feeding an extruder barrel with at least one hygroscopic starting material;
b) a vent stuffer at a location down-stream of the feeding location of step a) and up-stream of a first kneading and melting section; and
c) extruding the mixture.

2. The extrusion process according to claim 1, wherein the resultant product is a food or confectionary product.

3. The extrusion process according to claim 1, wherein the resultant product is a food.

4. The process according to claim 1, wherein the hygroscopic starting material has a water activity between 0.1 to 0.4 and a transition temperature below 40° C.

5. The process according to claim 4, wherein the hygroscopic starting material has an water activity between 0.1 to 0.4 and a glass transition temperature between −10° C. to 40° C.

6. The process according to claim 1, wherein a vacuum of the vent stuffer is from 400 to 950mbar.

7. The process according to claim 1, wherein the kneading and melting section is an area in the extrusion process wherein the glass transition temperature of the mixture is exceeded through thermo-mechanical energy.

8. The process according to claim 1, wherein a liquid is injected into the extruder.

9. The process according to claim 1, wherein the extrusion process does not include a vent stuffer at a location down-stream of a first kneading and melting section and a front plate.

10. An extruder system suitable for extruding compositions with at least one hygroscopic starting material, comprising: an extruder, a dry-feed dosing system, a vent stuffer, one or more extruder barrels, a liquid injection system and a front plate, wherein the vent stuffer is at a location down-stream of the feeding location and up-stream of the a first kneading and melting section of the extruder system.

11. The extruder system according to claim 10, wherein extruder system does not include a vent stuffer at a location down-stream of a first kneading and melting section and a front plate.

12-14. (canceled)
